(19) United States
(12) Patent Application Publication
(10) Pub. No.: US 2022/0162081 A1
(43) Pub. Date: May 26, 2022

(54) CHABAZITE ZEOLITE SYNTHESIS WITH COMBINED ORGANIC TEMPLATES

(71) Applicants: Lifeng WANG, Bryn Mawr, PA (US); Bjorn MODEN, West Chester, PA (US); Hong-Xin LI, Lansdale, PA (US); Nathaniel J. ROECKEL, Conshohocken, PA (US)

(72) Inventors: Lifeng WANG, Bryn Mawr, PA (US); Bjorn MODEN, West Chester, PA (US); Hong-Xin LI, Lansdale, PA (US); Nathaniel J. ROECKEL, Conshohocken, PA (US)

(21) Appl. No.: 17/531,228

(22) Filed: Nov. 19, 2021

Related U.S. Application Data
(60) Provisional application No. 63/116,432, filed on Nov. 20, 2020.

(51) Int. Cl. C01B 39/48; B01J 29/72; F01N 3/20; B01J 35/10; B01J 37/04; B01J 37/08

(52) U.S. Cl. CPC C01B 39/48; B01J 29/723; F01N 3/2066; B01J 35/006; B01J 37/04; B01J 37/08; F01N 2570/14; B01J 35/1052

(57) ABSTRACT

An as-synthesized microporous material having a CHA structure and containing a first and a second organic structure directing agent (OSDA), wherein the first OSDA has the following general structure of the quaternary ammonium cation is disclosed:

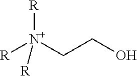

A microporous crystalline material made from the as-synthesized material is also disclosed. A method of making microporous crystalline material using combined organic structure directing agents is also disclosed. A method of selective catalytic reduction of nitrogen oxides in exhaust gas that comprises contacting exhaust gases, typically in the presence of ammonia, urea, an ammonia generating compound, or a hydrocarbon compound, with an article comprising the disclosed microporous crystalline is further disclosed.

This application claims priority to U.S. Provisional Patent Application No. 63/116,432, filed Nov. 20, 2020, which is hereby incorporated by reference in its entirety.

### TECHNICAL FIELD

The present disclosure relates generally to as-synthesized microporous material having a CHA structure produced using combined organic structure directing agents (OSDAs), the resulting chabazite (CHA) zeolites, and method of using the chabazite zeolite for selective catalytic reduction (SCR).

### BACKGROUND

Nitric oxides (NOx) have long been known to be polluting gases, principally by reason of their corrosive action. In fact, they are the primary reason for the cause of acid rain. A major contributor of pollution by NOx is their emission in the exhaust gases of diesel automobiles and stationary sources such as coal-fired power plants and turbines. To avoid these harmful emissions, SCR is employed and involves the use of zeolitic catalysts in converting NOx to nitrogen and water.

In commercial selective catalytic reduction (SCR) systems, aluminosilicate CHA-type zeolites are important components for NOx abatement in automotive applications. To obtain chabazite zeolites with desired chabazite zeolite composition, such as silica to alumina ratio (SAR) range 10-50, organic structure directing agents (OSDAs) were used as templates for chabazite zeolites synthesis. For example, N,N,N-Trimethyl-1-adamantylammonium hydroxide was a typical OSDA used for high quality chabazite synthesis. However, OSDAs such as N,N,N-Trimethyl-1-adamantylammonium hydroxide (TMAAOH) are known to increase the cost for the large scale commercial use of chabazite zeolites.

There has been an increasing need for replacing the expensive OSDA or reducing the amount of the expensive OSDA in the chabazite synthesis with a less expensive OSDA. There is also a need for synthesis method that allow enhanced economics of production of chabazite zeolites with high quality, and ultimately to allow for its application in the selective catalytic reduction of NOx in exhaust gases.

### SUMMARY

To address the foregoing needs, there is disclosed as-synthesized microporous material having a CA structure and comprising a first OSDA and a second OSDA, wherein the first OSDA has a general structure of the quaternary ammonium cation as follows:

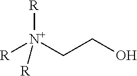

where R is a methyl or ethyl. When all three R groups are methyl groups, the resulting cation is called choline. In an embodiment, the second OSDA comprises N,N,N-Trimethyl-1-adamantylammonium hydroxide. Because of the use of the low-cost first OSDA, the amount of the typical second OSDA can be reduced significantly.

There is also disclosed a microporous crystalline material made by calcining the as-synthesized microporous material that is described herein.

There is further disclosed a method of selective catalytic reduction of nitrogen oxides in exhaust gas. In an embodiment, the method comprises at least partially contacting exhaust gases with an article comprising a microporous crystalline material described herein. The contacting step may be performed in the presence of ammonia, urea, an ammonia generating compound, or a hydrocarbon compound.

In an embodiment, there is disclosed a method of making microporous crystalline material having a molar silica to alumina ratio (SAR) of at least 8, such as 8 to 50, and made using a first OSDA having a general structure of the quaternary ammonium cation as follows:

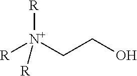

where R is a methyl or ethyl.

In an embodiment, the method comprises mixing sources of alumina, silica, alkali metal, a first OSDA of choline cation and a second OSDA, and water to form a gel, heating the gel in an autoclave to form a crystalline CIA product, and calcining the CHA product.

### BRIEF DESCRIPTION OF THE DRAWINGS

The accompanying figures are incorporated in and constitute a part of this specification.

FIG. 1 is an X-ray diffraction pattern of an inventive chabazite product made according to Example 1.

FIG. 2 is an X-ray diffraction pattern of an inventive chabazite product made according to Example 3.

FIG. 3 is an X-ray diffraction pattern of an inventive chabazite product made according to Example 4.

FIG. 4 is an X-ray diffraction pattern of an inventive chabazite product made according to Example 5.

FIG. 5 is an X-ray diffraction pattern of an inventive chabazite product made according to Example 6.

FIG. 6 is an X-ray diffraction pattern cited from FIG. 1 of patent U.S. Pat. No. 9,962,688 B2. The impurity peaks are marked with star symbol for clarity.

FIG. 7 is an X-ray diffraction pattern of a chabazite product made according to Comparative Example 1.

FIG. 8 is an X-ray diffraction pattern of a chabazite product made according to Comparative Example 2.

FIG. 9 is SCR activity over Example 2 after a hydrothermal treatment at 750° C. for 16 hours in 10% H₂O/air.

FIG. 10 is an X-ray diffraction pattern of an inventive chabazite product made according to Example 7.

FIG. 11 is an X-ray diffraction pattern of an inventive chabazite product made according to Example 8.

FIG. 12 is an X-ray diffraction pattern of a chabazite product made according to Comparative Example 3.

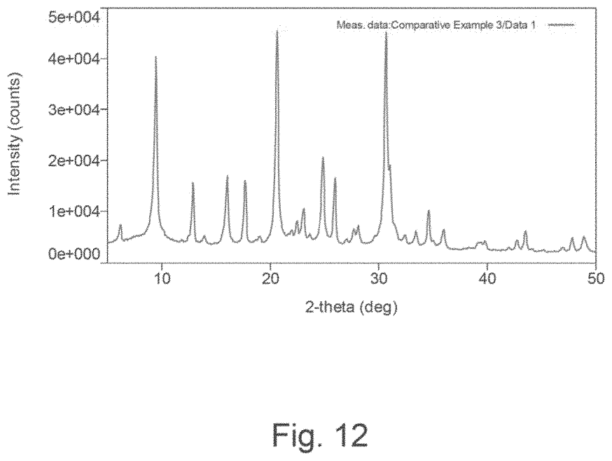

FIG. 13 is a scanning electron microscope (SEM) image of Example 7.

FIG. 14 is a scanning electron microscope (SEM) image of Example 8.

### DESCRIPTION

### Definitions

“As-synthesized” means a microporous crystalline material that is the solid product of a crystallized gel, prior to calcination.

“Hydrothermally stable” means having the ability to retrain a certain percentage of initial surface area and/or microporous volume after exposure to elevated temperature and/or humidity conditions (compared to room temperature) for a certain period of time. For example, in one embodiment, it is intended to mean retaining at least 75%, such as at least 80%, at least 90%, or even at least 95%, of its surface area, micropore volume and XRD pattern intensity after exposure to conditions simulating those present in an automobile exhaust, such as temperatures up to 900° C., including temperatures ranging from 700 to 900° C. in the presence of up to 10 volume percent (vol %) water vapor for times ranging from up to 1 hour, or even up to 16 hours, such as for a time ranging from 1 to 16 hours.

“Initial Surface Area” means the surface area of the freshly made crystalline material before exposing it to any aging conditions.

“Micropore volume” is used to indicate the total volume of pores having a diameter of less than 20 angstroms. “Initial Micropore Volume” means the micropore volume of the freshly made crystalline material before exposing it to any aging conditions. The assessment of micropore volume is particularly derived from the BET measurement techniques by an evaluation method called the t-plot method (or sometimes just termed the t-method) as described in the literature (Journal of Catalysis 3, 32 (1964)).

Herein “mesopore volume” is the volume of pores having a diameter of greater than 20 angstroms up to the limit of 600 angstroms.

Similarly, “micropore area” refers to the surface area in pores less 20 angstroms, and “mesopore area” refers to the surface area in pores between 20 angstroms and 600 angstroms.

“Defined by the Structure Commission of the International Zeolite Association,” is intended to mean those structures included but not limited to, the structures described in “Atlas of Zeolite Framework Types,” ed. Baerlocher et al. Sixth Revised Edition (Elsevier 2007), which is herein incorporated by reference in its entirety.

“Double-6-rings (d6r)” is a structural building unit described in “Atlas of Zeolite Framework Types,” ed. Baerlocher et al., Sixth Revised Edition (Elsevier 2007), which is herein incorporated by reference in its entirety.

“Selective Catalytic Reduction” or “SCR” refers to the reduction of NOₓ (typically with urea and/or ammonia) in the presence of oxygen to form nitrogen and H₂O.

“Exhaust gas” refers to any waste gas formed in an industrial process or operation and by internal combustion engines, such as from any form of motor vehicle.

The phrases “chosen from” or “selected from” as used herein refers to selection of individual components or the combination of two (or more) components. For example, catalytically active metal described herein may be chosen from copper and iron, which means the metal may comprise copper, or iron, or a combination of copper and iron.

In a first embodiment, there is described an as-synthesized mesoporous material having a CHA structure and comprising a first OSDA and a second OSDA. The first organic structure directing agent (OSDA) that has a general structure of the quaternary ammonium cation as follows:

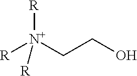

where R is a methyl or ethyl.

In one embodiment, there is described an as-synthesized microporous material having a CHA structure and comprising a first OSDA of choline cation and a second OSDA.

In an embodiment, at least one OSDA is a hydroxide or a salt chosen from fluoride, chloride, bromide, iodide, or a mixture thereof.

Applicants have discovered that the use of the first OSDA choline cation and a second OSDA can lead to formation of CH A type zeolite with high quality evidenced by XRD, surface area and micropore volume.

The first OSDA can be used in a hydroxide form or in a salt form, including but not limited to fluoride, chloride, bromide, iodide, or acetate forms, or a mixture of thereof.

Applicants have discovered that the use of the first OSDA and a second OSDA, which is used in lower than typically practiced quantities, can lead to formation of CHA type zeolite. The first OSDA has a choline cation structure.

In an embodiment, the first OSDA can be used in a hydroxide form or in a salt form, including but not limited to fluoride, chloride, bromide, iodide, or acetate forms, or a mixture of thereof.

In an embodiment, the second OSDA is N,N,N-trimethyl-1-adamantylammonium, N-ethyl-N,N-dimethylcyclohexylammonium, or benzyltrimethylammonium in a hydroxide form or in a salt form, including but not limited to fluoride, chloride, bromide, iodide, or acetate forms, or a mixture of thereof.

There is disclosed a useful microporous crystalline material produced using one or more OSDAs, having a molar silica to alumina ratio (SAR) of at least 8, such as ranging from 8 to 50. The disclosed materials are particularly useful for selective catalytic reduction of nitric oxides.

In an embodiment, the microporous crystalline material may comprise a crystal structure having structural code of CHA (chabazite). Zeolitic materials having CHA framework type are three-dimensional 8-membered-ring pore/channel systems containing double-six-rings and cages.

In an embodiment, the as-synthesized microporous material described herein may be used to make a microporous crystalline material made by calcining the as-synthesized microporous material.

In an embodiment, the microporous crystalline material may further comprise at least one catalytically active metal, such as copper or iron. In an embodiment, the catalytically active metal comprises copper Cu, which is present in a CuO of at least 1 wt %, such as 1-10 wt %. In an embodiment, the catalytically active metal comprises iron Fe, which is present in a Fe₂O₃ of at least 0.2 wt %, such as 0.2-10 wt %.

There is also disclosed a method of selective catalytic reduction of nitrogen oxides in exhaust gas. In an embodiment, the method comprises at least partially contacting the exhaust gases with an article comprising a microporous crystalline material described herein. The contacting step is typically performed in the presence of ammonia, urea, an ammonia generating compound, or a hydrocarbon compound.

There is also described a method of making microporous crystalline material described herein. In an embodiment, the method comprises mixing sources of alumina, silica, alkali containing additive, one or more organic structural directing agents, and water to form a gel. The method further comprises heating the gel in an autoclave to form a crystalline CIA product, and calcining said CHA product.

In an embodiment, the method further comprises introducing at least one catalytically active metal, such as copper or iron, into the microporous crystalline material by liquid-phase or solid-phase ion exchange, impregnation, direct synthesis or combinations thereof.

In an embodiment, the catalytically active metal comprises copper Cu, which is present in a CuO of at least 1 wt %, such as 1-10 wt %. In an embodiment, the catalytically active metal comprises iron Fe, which is present in a Fe₂O₃ of at least 0.2 wt %, such as 0.2-10 wt %.

The method described herein uses two or more OSDAs to form the resulting zeolite material. The first OSDA has a general structure of choline cation.

In one embodiment, the first OSDA can be used in a hydroxide form or in a salt form, including but not limited to fluoride, chloride, bromide, iodide, or acetate forms, or a mixture of thereof.

In one embodiment, the microporous crystalline material is produced using two or more OSDAs, where the second OSDA is N,N,N-trimethyl-1-adamantylammonium, N-ethyl-N,N-dimethylcyclohexylammonium, or benzyltrimethylammonium in a hydroxide form or in a salt form, including but not limited to fluoride, chloride, bromide, iodide, or acetate forms, or a mixture of thereof.

In another embodiment, the second organic structural directing agent may comprise a compound capable of forming a zeolite with chabazite (CHA) structure. For example, the second organic structural directing agent may comprise a compound, such as an amine, monoquaternary ammonium compound, or diquaternary ammonium compound, capable of forming a zeolite with chabazite (CHA) structure. Non-limiting examples of the compounds capable of forming a zeolite with a CHA structure include N,N-dimethyl-N-ethylcyclohexylammonium, N,N-dimethylpyrrolidinium, N,N-dimethylpiperidinium, N,N-dimethylhexahydroazepiniumn, benzyltrimethylammonium, and mixtures thereof. These compounds, methods of making them, and methods of using them to synthesize CHA zeolite materials are described in U.S. Pat. Nos. 7,670,589, 7,597,874 B1, and WO 2013/035054, all of which are incorporated herein by reference.

In an embodiment, the alkali containing additive comprises a source of potassium, sodium or a mixture of sodium and potassium. Examples include potassium hydroxide, potassium aluminate, sodium hydroxide and sodium aluminate, respectively.

In an embodiment, the sources of aluminum include but are not limited to sodium aluminate, aluminum salts, aluminum hydroxide, aluminum containing zeolites, aluminum alkoxides, or alumina. The sources of silica can include but are not limited to sodium silicate, potassium silicate, silica gel, silica sol, finned silica, silica-alumina, zeolites, silicon alkoxides, or precipitated silica.

In an embodiment, the gel is heated in the autoclave at a temperature ranging from 120-200° C. for 1-100 hours, such as 140° C. for 96 hours. The method may further comprise filtering the gel to form a solid product, rinsing the solid product with DI water, drying the rinsed product, calcining the dried product, ammonium or proton exchanging the calcined product.

Measurement Techniques:

Surface area measurements. Surface area was determined in accordance with the well-known BET (Brunauer-Emmett-Teller) nitrogen adsorption technique, also referred to as the “BET method.” Herein the general procedure and guidance of ASTM D4365-95 is followed in the application of the BET method to the materials according to the present disclosure. To ensure a consistent state of the sample to be measured, all samples are pretreated. Suitably pretreatment involves heating the sample, for example to a temperature of 400 to 500° C., for a time sufficient to eliminate free water, such as 3 to 5 hours. In one embodiment, the pretreatment comprises heating each sample to 500° C. for 4 hours. In an embodiment, the surface area of the inventive material ranges from 500 to 900 m²/g, such as 550 to 900 m²/g, 600 to 900 m²/g, 650 to 900 m²/g or even above 700 m²/g, such as 700-900 m²/g.

Micropore volume measurements. The assessment of micropore volume is particularly derived from the BLT measurement techniques by an evaluation method called the t-plot method (or sometimes just termed the t-method) as described in the literature (Journal of Catalysis 3, 32 (1964)).

In an embodiment, the zeolitic chabazite materials described herein typically have a micropore volume above 0.12 cm³/g. In an embodiment, the micropore volume of the inventive material ranges from 0.12 to 0.30 cm/g, such as 0.15 to 0.30 cm³/g, 0.18 to 0.30 cm³/g, 0.21 to 0.30 cm³/g, or above 0.24 cm³/g, such as 0.24 to 0.30 cm³/g.

Acidity measurements. n-Propylamine was used as a probe molecule for determining the acidity of the CH A materials, since n-Propylamine selectively chemisorbs (chemically adsorbs) on the Bronsted acid sites of CHA. A thermal gravimetric analyzer (TGA) system was used for the measurement, where physically adsorbed n-propylamine was removed by heating to 280° C., and chemically adsorbed n-propylamine was determined from the weight change in a temperature range of 280-500° C. The acidity (acid site density) values were calculated in the unit of mmol/g from the weight change between 280 and 500° C. The following reference is incorporated by reference for its teachings related to acidity measurements, D. Parrillo et al., Applied Catalysis, vol. 67, pp. 107-118, 1990.

SCR catalytic tests. The activities of the hydrothermally aged materials for NOₓ conversion, using NH₃ as reductant, were tested with a flow-through type reactor. Powder zeolite samples were pressed and sieved to 35/70 mesh and loaded into a quartz tube reactor. The gas composition for NH₃-SCR was 500 ppm NO, 500 ppm NH₃, 5 vol % O₂, 0.6% H₂O and balance N₂. The space velocity was 50,000 h⁻¹. The reactor temperature was ramped between 150 and 550° C., and NO conversion was determined with an MKS MultiGas infrared analyzer at each temperature point.

XRD retention. The XRD peak areas for Cu-exchanged fresh and steamed samples were measured to calculate the XRD retention, i.e. the fraction of the original XRD peak area that was retained following the steam treatment. The XRD peaks between 19-32 degrees two-theta were used in the area calculations. The XRD retention was calculated by taking the ratio of the peak area of the steamed sample and the peak area of the sample before steaming.

### EXAMPLES

The following non-limiting examples, which are intended to be exemplary, further clarify the present disclosure.

### Example 1. Synthesis of 13 SAR CHA

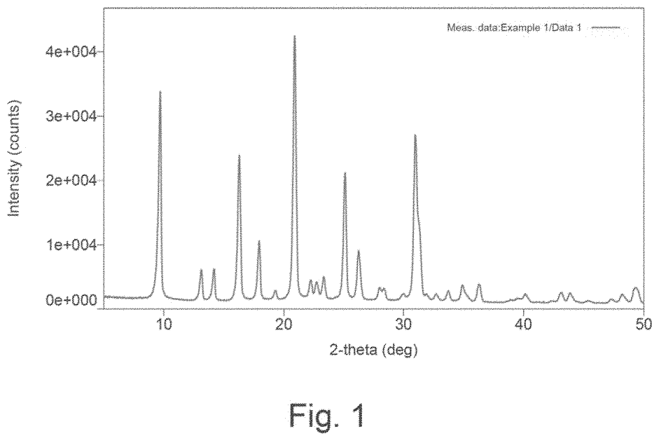

250 grams of de-ionized(DI) water, 63 grants of N,N,N-Trimethyl-1-adamantylammonium hydroxide (Sachem, 25 wt % solution), 67 grams of choline hydroxide (48 wt % solution) were added together to form a mixture. Next, 52 grams of sodium aluminate (Southern Ionics, 23.5 wt % Al₂O₃) was added to the mixture. 268 grams of silica sol (Ludox AS-40, W.R. Grace, 40 wt % SiO₂) was then added to the mixture, followed by the addition of 1.44 grams of seeds of CHA structure. The molar composition of the gel was [14.35 SiO₂:1.0 Al₂O₃: 1.32 Na₂O:0.6 TMAAOH:2.13 Choline hydroxide:233 H₂O]. The resulting gel was crystallized at 140° C. for 96 hours in an autoclave (Parr Instruments). The recovered solid was filtered, rinsed with DI water and dried in air at 105° C., overnight. The XRD pattern of Example 1 is shown in FIG. 1. According to the XRD pattern in FIG. 1, the sample from Example 1 is a phase pure chabazite.

The dried zeolite powder was calcined in air for 1 hour at 450° C., followed by 6 hours 550° C. using a ramp rate of 3° C./min. The calcined sample had a surface area of 776 m²/g and a micropore volume of 0.29 cm³/g. The acidity of the ammonium-exchanged sample determined by n-propylamine adsorption was 1.39 mmol/g. The properties of the sample are summarized in Table 1.

### Example 2. Cu-Exchange of Example 1

The ammonium-exchanged zeolite from Example 1 was Cu-exchanged with Cu-nitrate to achieve a CuO content of 5.7 wt % CuO. This Cu-exchanged material was further steamed at 750° C. for 16 hours in 10% H₂O/air. The properties of Example 2 are summarized in Table 2 and the NO conversion obtained for the steamed sample is shown in Table 3.

### Example 3. Synthesis of 11 SAR CHA

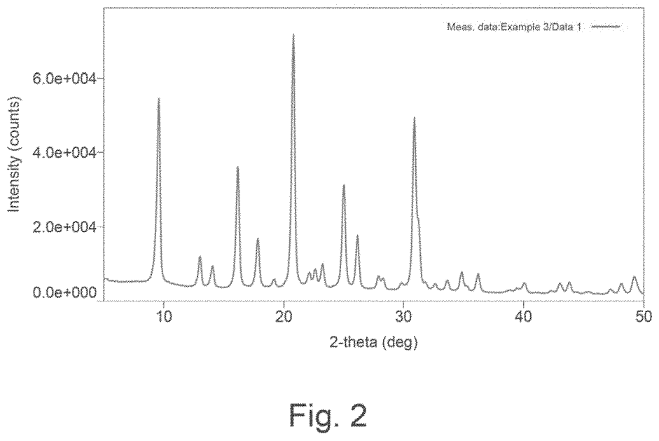

230 grams of de-ionized (DI) water, 46 grams of N,N,N-Trimethyl-1-adamantylammonium hydroxide (Sachem, 20 wt % solution), 8 grains of NaOH (50 wt % solution) and 67 grams of choline hydroxide (48 wt % solution) were added together to form a mixture. Next, 52 grams of sodium aluminate (Southern tonics, 23.5 wt % Al₂O₃) was added to the mixture. 268 grams of silica sol (Ludox AS-40. W. R. Grace, 40 wt % SiO₂) was then added to the mixture, followed by the addition of 1.44 grams of seeds of CHA structure. The molar composition of the gel was [14.35 SiO₂:1.0 Al₂O₃:1.72 Na₂O:0.35 TMAAOH:2.13 Choline hydroxide:222 H₂O]. The resulting gel was crystallized at 140° C. for 96 hours in an autoclave (Parr Instruments). The recovered solid was filtered, rinsed with DI water and dried in air at 105° C., overnight. The XRD pattern of Example 3 is shown in FIG. 2. According to the XRD pattern in FIG. 2, the sample from Example 3 is a phase pure chabazite.

The dried zeolite powder was calcined in air for 1 hour at 450° C. followed by 6 hours 550° C. using a ramp rate of 3° C./min. The calcined sample had a surface area of 742 m²/g and a micropore volume of 0.27 cm³/g. The acidity of the ammonium-exchanged sample determined by n-propylamine adsorption was 1.49 mmol/g. The properties of the sample are summarized in Table 1.

### Example 4. Synthesis of 13 SAR CA

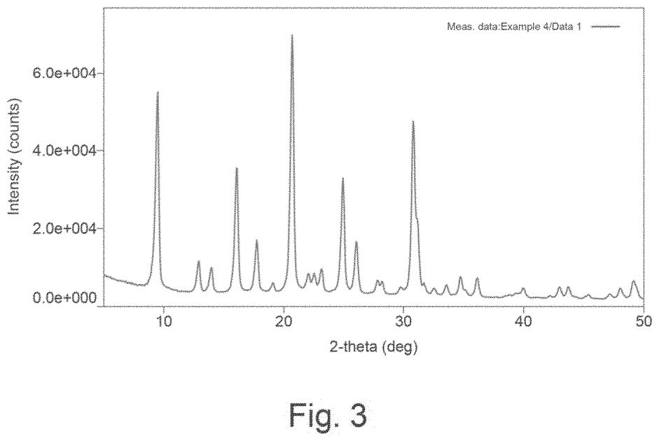

250 grams of de-ionized (DI) water, 58 grams of N,N,N-Trimethyl-1-adamantylammonium hydroxide (Sachem, 20 wt % solution), 8 grams of NaOH (50% solution) and 30 grams of choline chloride (≥98 wt %) were added together to form a mixture. Next, 52 grams of sodium aluminate (Southern Ionics, 23.5 wt % Al₂O₃) was added to the mixture. 268 grams of silica sol (Ludox AS-40. W. R. Grace, 40 wt % SiO₂) was then added to the mixture, followed by the addition of 1.44 grams of seeds of CHA structure. The molar composition of the gel was [14.35 SiO₂:1.0 Al₂O:1.72 Na₂O:0.44 TMAAOH:1.69 Choline Chloride:219 H₂O]. The resulting gel was crystallized at 140° C. for 96 hours in an autoclave (Parr Instruments). The recovered solid was filtered, rinsed with DI water and dried in air at 105° C. overnight. The XRD pattern of Example 4 is shown in FIG. 3. According to the XRD pattern in FIG. 3, the sample from Example 4 is a phase pure chabazite.

The dried zeolite powder was calcined in air for 1 hour at 450° C., followed by 6 hours 550° C. using a ramp rate of 3° C./min. The calcined sample had a surface area of 739 m²/V and a micropore volume of 0.27 cm³/g. The acidity of the ammonium-exchanged sample determined by n-propylamine adsorption was 1.35 mmol/g. The properties of the sample are summarized in Table 1.

### Example 5. Synthesis of 18 SAR CHA

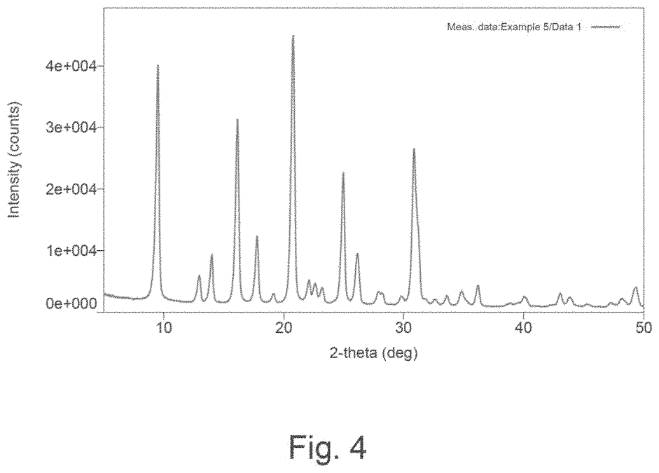

Example 5 was synthesized using the similar procedure to example 1. The molar composition of the gel was [20.0 SiO₂:1.0 Al₂O₃:1.59 Na₂O:1.06 TMAAOH:2.44 Choline hydroxide:318 H₂O]. The XRD pattern of Example 5 is shown in FIG. 4. According to the XRD pattern in FIG. 4, the sample from Example 5 is a phase pure chabazite.

The dried zeolite powder was calcined in air for 1 hour at 450° C., followed by 6 hours 550° C. using a ramp rate of 3° C./min. The calcined sample had a surface area of 764 m²/g and a micropore volume of 0.28 cm³/g. The acidity of the ammonium-exchanged sample determined by n-propylamine adsorption was 1.18 mmol/g. The properties of the sample are summarized in Table 1.

### Example 6. Synthesis of 27 SAR CHA

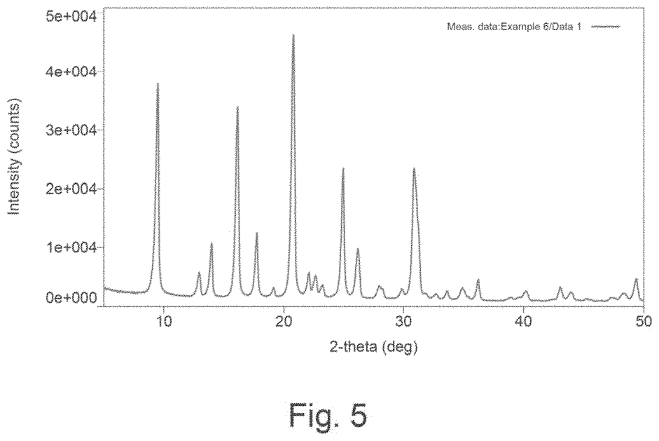

Example 6 was synthesized using the similar procedure to example 1. The molar composition of the gel was [28.8 SiO₂:1.0 Al₂O₃:2.04 Na₂O:1.53 TMAAOH:2.30 Choline hydroxide:464 H₂O]. The XRD pattern of Example 6 is shown in FIG. 5. According to the XRD pattern in FIG. 5, the sample from Example 6 is a phase pure chabazite.

The dried zeolite powder was calcined in air for 1 hour at 450° C., followed by 6 hours 550° C. using a ramp rate of 3° C./min. The calcined sample had a surface area of 748 m²/g and a micropore volume of 0.27 cm³/g. The acidity of the ammonium-exchanged sample determined by n-propylamine adsorption was 0.89 mmol/g. The properties of the sample are summarized in Table 1.

### Example 7. Synthesis of 14 SAR CHA

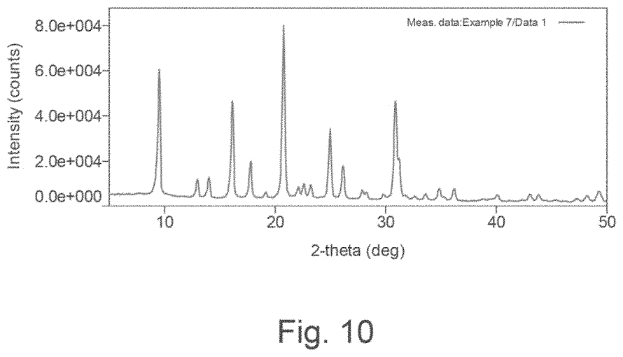

Example 7 was synthesized using a similar procedure as Example 1 except that KOH was added as an alkali source along with the Na from the sodium aluminate. The molar composition of the gel was [14.5 SiO₂:1.0 Al₂O₃:1.37 Na₂O:0.16 K₂O:0.61 TMAAOH: 1.76 Choline Chloride:205 H₂O]. The resulting gel was crystallized at 140° C. for 96 hours in an autoclave (Parr Instruments). The XRD pattern of Example 7 is shown in FIG. 10.

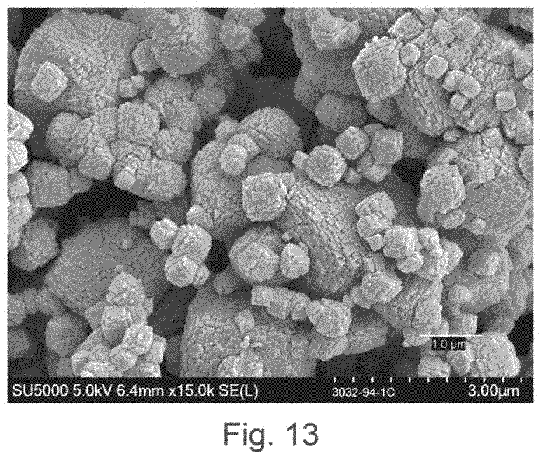

According to the XRD pattern in FIG. 10, the sample from Example 7 is a phase pure chabazite. An SEM image of Example 7 is shown in FIG. 13.

The dried zeolite powder was calcined in air for 1 hour at 450° C., followed by 6 hours 550° C. using a ramp rate of 3° C./min. The calcined sample had a surface area of 722 m²/g and a micropore volume of 0.26 cm³/g. The acidity of the ammonium-exchanged sample determined by n-propylamine adsorption was 1.42 mmol/g. The properties of the sample are summarized in Table 1.

### Example 8. Synthesis of 24 SAR CHA

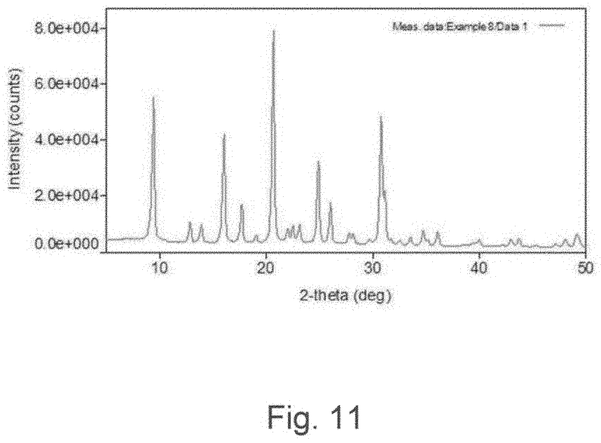

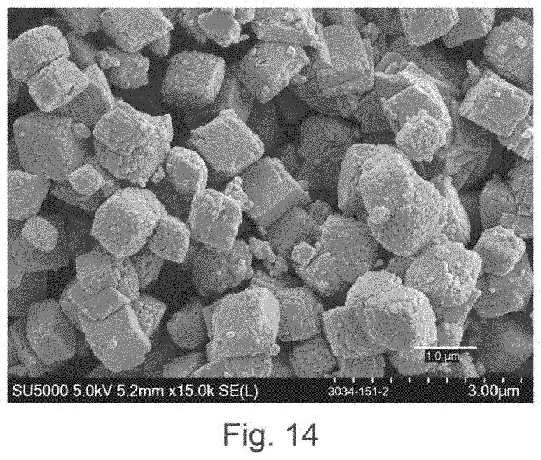

496.6 grams of de-ionized (DI) water, 122.5 grams of N,N-Trimethyl-1-adamantylammonium hydroxide (Sachem, 20 wt % solution), 16.3 grams of KOH (45 wt % solution), 9.5 grams of NaOH (50 wt % solution) and 42.6 grams of choline chloride (≥98 wt %) were added together to form a mixture. Next, 42.0 grams of sodium aluminate (Southern Ionics, 23.5 wt % Al₂O₃) was added to the mixture. 461.3 grams of silica sol (40 wt % SiO₂) was then added to the mixture, followed by the addition of 9.2 grams of seeds of CHA structure. The molar composition of the gel was [24.7 SiO₂:1.0 Al₂O₃:1.84 Na₂O:0.53 K₂:1.17 TMAAOH:2.46 Cholihe Chloride:405 H₂O]. The resulting gel was crystallized at 150° C. for 48 hours in an autoclave (Parr Instruments). The recovered solid was filtered, rinsed with DI water and dried in air at 105° C. overnight. The XRD pattern of Example 8 is shown in FIG. 11. According to the XRD pattern in FIG. 11, the sample front Example 8 is a phase pure chabazite. An SEM image of Example 8 is shown in FIG. 14.

The dried zeolite powder was calcined in air for 1 hour at 450° C., followed by 6 hours 550° C. using a ramp rate of 3° C./min. The ammonium-exchanged sample had a surface area of 783 m²/g and a micropore volume of 0.29 cm³/g. The acidity of the ammonium-exchanged sample determined by n-propylamine adsorption was 1.20 mmol/g. The properties of the sample are summarized in Table 1.

### Example 9. Cu-Exchange of Example 7

The ammonium-exchanged zeolite from Example 7 was Cu-exchanged with Cu-nitrate to achieve a CuO content of 5.5 wt % CuO. This Cu-exchanged material was further steamed at 750° C. for 16 hours in 10% H₂O/air. The properties of Example 9 are summarized in Table 2 and the NO conversion obtained for the steamed sample is shown in Table 3.

### Example 10. Cu-Exchange of Example 8

The ammonium-exchanged zeolite from Example 8 was Cu-exchanged with Cu-nitrate to achieve a CuO content of 3.7 wt % CuO. This Cu-exchanged material was further steamed at 850° C. for 5 hours in 10% H₂O-air. After steaming at 850° C. for 5 hours in 10% H₂O/air, the XRD retention was 88%. The NO conversion obtained for the steamed sample is shown in Table 4.

### Comparative Example 1. Synthesis of CHA

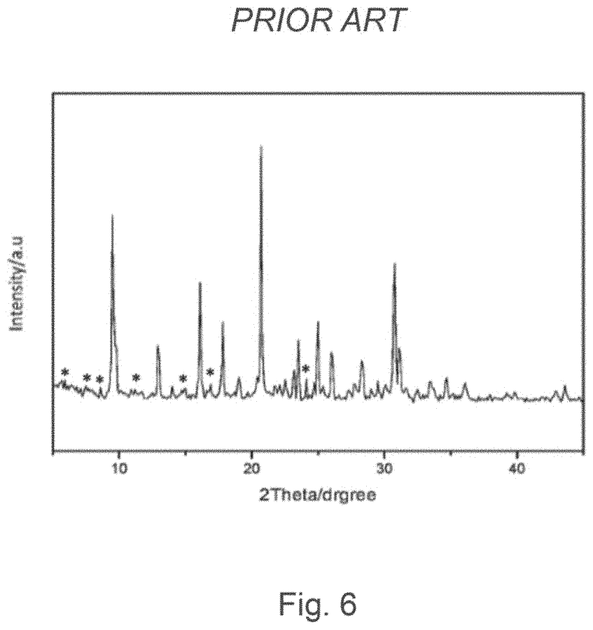

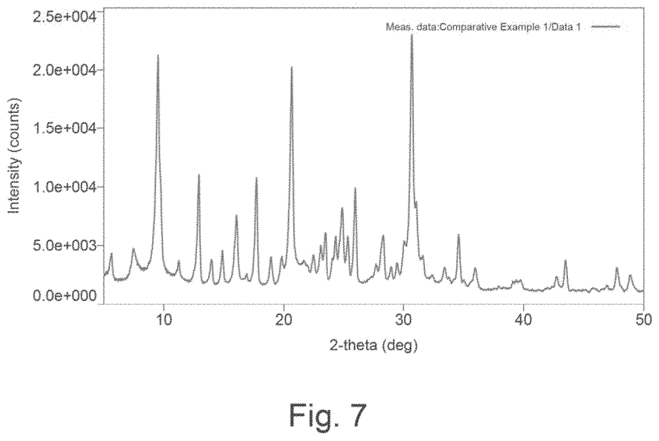

The method disclosed by Zhang et al. in U.S. Pat. No. 9,962,688 B2 (“the '688 patent”) describes the synthesis of SSZ-13 using choline cation as the only OSDA. As shown in the XRD pattern in FIG. 1 of the '688 patent, the obtained SSZ-13 contained an impurity phase other than CHA. FIG. 6 shows the XRD patter in FIG. 1 of the '688 patent with impurity peaks marked with star symbols. A sample was prepared following the gel formulation from Example 1 in the patent. Sodium metaaluminate, sodium hydroxide, deionized water, choline chloride, and Ludox AS-40 were mixed following the same procedure as Example 1. The molar composition of the gel was [40.19 SiO₂:1.0 Al₂O₃:16.19 Na₂O:5.47 Choline Chloride:540 H₂O]. The resulting gel was crystallized at 140° C. for 5 days in an autoclave (Parr Instruments). The XRD pattern of Comparative Example 1 is shown in FIG. 7. According to the XRD pattern in FIG. 7, the sample from Comparative Example 1 is not a phase pure chabazite.

The dried zeolite powder was calcined in air for 1 hour at 450° C., followed by 6 hours 550° C. using a ramp rate of 3° C./min. The calcined sample had a surface area of 447 m²/g and a micropore volume of 0.17 cm³/g. The properties of the sample are summarized in Table 1.

### Comparative Example 2. Synthesis of CHA

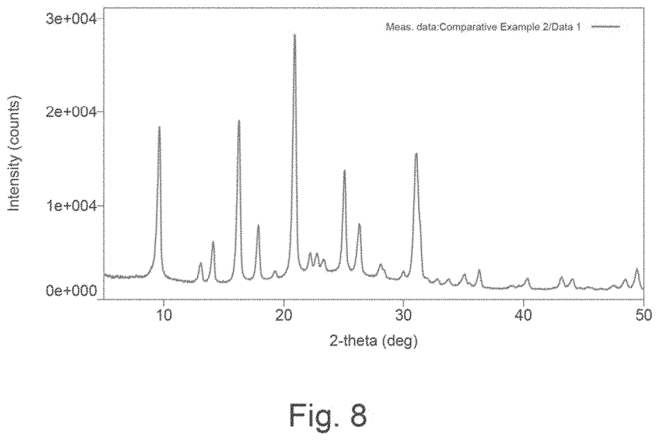

Comparative Example 2 was synthesized using a procedure similar to Example 5 but with TMAAOH as the sole OSDA. The molar composition of the gel was [20.0 SiO₂:1.0 Al₂O₃:1.45 Na₂O:1.06 TMAAOH:299 H₂O]. The resulting gel was crystallized at 140° C. for 4 days in an autoclave (Parr Instruments). The XRD pattern of Comparative Example 2 is shown in FIG. 8. According to the XRD pattern in FIG. 8, the sample from Comparative Example 2 had much lower intensity than Example 5 shown in FIG. 4. The sample from Comparative Example 2 in FIG. 8 also contained a halo between 20-30° associated with amorphous material being present in Comparative Example 2 in addition to CHA.

The dried zeolite powder was calcined in air for 1 hour at 450° C., followed by 6 hours 550° C. using a ramp rate of 3° C./min. The calcined sample had a surface area of 540 m²/g and a micropore volume of 0.20 cm³/g. The lower measured surface area on Comparative Example 2 relative to Example 5 is consistent with the amorphous halo observed in the XRD pattern in FIG. 8.

### Comparative Example 3. Synthesis of CHA

Comparative Example 3 was synthesized using the similar procedure to Comparative Example 1. The molar composition of the gel was [40.2 SiO₂:1.0 Al₂O₃:16.17 Na₂O:5.53 Choline Chloride:512 H₂O]. The resulting gel was crystallized at 140° C. for 6 days in an autoclave (Parr Instruments). The XRD pattern of comparative Example 3 is shown in FIG. 13. According to the XRD pattern in FIG. 13, the sample from comparative Example 3 is not a phase pure chabazite.

The dried zeolite powder was calcined in air for 1 hour at 450° C., followed by 6 hours 550° C. using a ramp rate of 3° C./min. The calcined sample had a surface area of 602 m²/g and a micropore volume of 0.22 cm³/g. The properties of the sample are summarized in Table 1.

### Comparative Example 4. Cu-Exchange of Comparative Example 2

The ammonium-exchanged zeolite from Comparative Example 2 was Cu-exchanged with Cu-nitrate to achieve a CuO content of 5.0 wt % CuO. This Cu-exchanged material was further steamed at 750° C. for 16 hours in 10% H₂O/air. The properties of Comparative Example 4 are summarized in Table 2 and the NO conversion obtained for the steamed sample is shown in Table 3.

### Comparative Example 5. Cu-Exchange of Comparative Example 3

The ammonium-exchanged zeolite from Comparative Example 2 was Cu-exchanged with Cu-nitrate to achieve a CuO content of 5.0 wt % CuO. This Cu-exchanged material was further steamed at 750° C. for 16 hours in 10% H₂O/air. The properties of Comparative Example 5 are summarized in Table 2 and the NO conversion obtained for the steamed sample is shown in Table 3.

TABLE 1
Analytical data for materials prepared
in Inventive and Comparative Examples.

| | | | | | | Al_{f}/Alₜₒₜ |
|---|---|---|---|---|---|---|
| | | SA | MPV | | Acidity | (atomic |
| Example | XRD pattern | (m²/g) | (cm³/g) | SAR | (mmol/g) | ratio) |
| Example 1 | CHA | 776 | 0.29 | 13.0 | 1.39 | 0.61 |
| Example 3 | CHA | 742 | 0.27 | 11.2 | 1.49 | 0.58 |
| Example 4 | CHA | 739 | 0.27 | 12.6 | 1.35 | 0.58 |
| Example 5 | CHA | 764 | 0.28 | 18.4 | 1.18 | 0.71 |
| Example 6 | CHA | 748 | 0.27 | 27.0 | 0.89 | 0.77 |
| Example 7 | CHA | 722 | 0.26 | 13.5 | 1.42 | 0.65 |
| Example 8 | CHA | 783 | 0.29 | 23.6 | 1.20 | 0.91 |
| Comp. Ex. 1 | CHA/ | 447 | 0.17 | — | — | |
| | impurity | | | | | |
| Comp. Ex. 2 | CHA/ | 540 | 0.20 | 21.4 | 0.87 | 0.60 |
| | Amorphous | | | | | |
| Comp. Ex. 3 | CHA/ | 602 | 0.22 | 6.9 | 1.75 | 0.45 |
| | impurity | | | | | |

The XRD patterns of the Cu-exchanged materials were measured before and after the hydrothermal treatment to obtain the XRD retention and the results are summarized in Table 2. The zeolite prepared using the disclosed methods described herein remained highly crystalline after hydrothermal treatment at 750° C., whereas the comparative examples had lower XRD retention, such as 71% or lower.

Cu-exchanged versions of inventive and comparative examples were also evaluated for SCR activity, and results are summarized in Table 3. The ammonium exchanged zeolites were Cu-exchanged with Cu-nitrate to achieve a CuO content of 3-6 wt % CuO. The Cu-exchanged materials were further steamed at 750° C., for 16 hours in 10% H₂O/air. The inventive examples retained a higher stability and had higher NOx conversion at low temperatures such as 150° C. and 200° C.

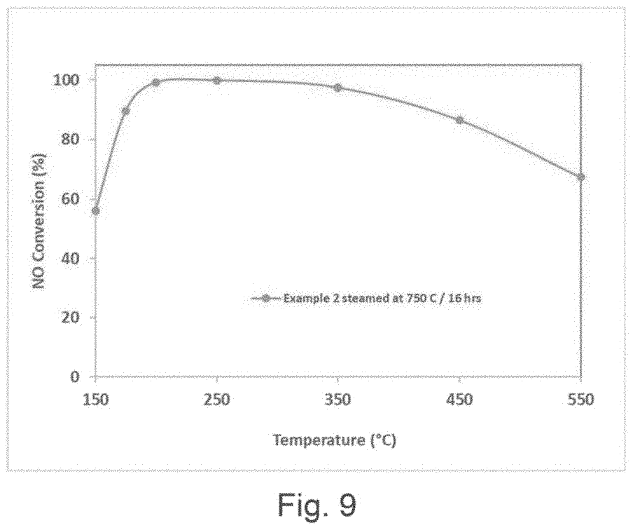

Example 2 had a SAR of 12.5 and contained 5.7% CuO. The steamed Example 2 was evaluated for SCR activity, and results are shown in FIG. 9. The steamed Example 2 had 92% XRD retention after steaming at 750° C. for 16 hours and exhibited excellent SCR activity.

TABLE 2
X-ray diffraction retention of Cu-exchanged
examples and comparative examples after steaming
at 750° C. for 16 hours in 10% H₂O/air.

| | | | | XRD |
|---|---|---|---|---|
| | | CuO | Steam-calcination | retention |
| Example | SAR | (%) | temps. (° C.)/hrs | (%) |
| Example 2 | 12.5 | 5.7 | 750/16 | 92 |
| Example 9 | 13.5 | 5.5 | 750/16 | 84 |
| Comp. Ex. 4 | 21.4 | 5.0 | 750/16 | 71 |
| Comp. Ex. 5 | 6.9 | 5.0 | 750/16 | <5 |

TABLE 2
X-ray diffraction retention of Cu-exchanged
examples and comparative examples after
steaming at 750° C. for 16 hours in 10% H₂O/air.

| | | | | XRD |
|---|---|---|---|---|
| | | | Steam-calcination | retention |
| Example | SAR | CuO (%) | temps. (° C.)/hrs | (%) |
| Example 2 | 12.5 | 5.7 | 750/16 | 92 |
| Example 9 | 13.5 | 5.5 | 750/16 | 84 |
| Comp. Ex. 4 | 21.4 | 5.0 | 750/16 | 71 |
| Comp. Ex. 5 | 6.9 | 5.0 | 750/16 | <5 |

TABLE 4
NO conversion in % (SCR activity) at 150-550° C. for Cu-exchanged
Example 10 that has been steamed at 850° C. for 5 hours in 10% steam.

| | Temperature | | | | | | |
|---|---|---|---|---|---|---|---|
| | 150° C. | 175° C. | 200° C. | 250° C. | 350° C. | 450° C. | 550° C. |
| Example | Conv. (%) | Conv. (%) | Conv. (%) | Conv. (%) | Conv. (%) | Conv. (%) | Conv. (%) |
| Example 10 | 39 | 71 | 98 | 100 | 99 | 81 | 62 |

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present disclosure.

Other embodiments of the invention will be apparent to those skilled in the art from consideration of the specification and practice of the invention disclosed herein. It is intended that the specification and examples be considered as exemplary only, with the true scope of the invention being indicated by the following claims.

What is claimed is:

1. An as-synthesized microporous material having a CHA structure and comprising:
a first organic structure directing agent (OSDA) that has a general structure of the quaternary ammonium cation as follows: 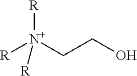
where R is a methyl or ethyl; and
at least one second OSDA.

2. The as-synthesized microporous material of claim 1, which has a molar silica to alumina ratio (SAR) of about 8 or higher.

3. The as-synthesized microporous material of claim 2, wherein the SAR ranges from 8 to 50.

4. The as-synthesized microporous material of claim 1, wherein the first OSDA and the second OSDA are a hydroxide or a salt chosen from fluoride, chloride, bromide, iodide, or a mixture of thereof.

5. The as-synthesized microporous material of claim 1, wherein the second OSDA comprises a compound chosen from an amine, monoquaternary ammonium compound, or diquaternary ammonium compound, capable of forming a zeolite with chabazite (CHA) structure.

6. The as-synthesized microporous material of claim 5, wherein the second OSDA is chosen from N,N,N-trimethyl-1-adamantylammonium, N,N-dimethyl-N-ethylcyclohexylammonium, N,N-dimethylpyrrolidinium, N,N-dimethylpiperidinium, N,N-dimethylhexahydroazepinium, benzyltrimethylammonium, and mixtures thereof.

7. The as-synthesized microporous material of claim 1, wherein the first OSDA comprises choline cation.

8. A microporous crystalline material comprising a calcined and ammonium-exchanged material of claim 1.

9. The microporous crystalline material of claim 8, further comprising at least one catalytically active metal.

10. The microporous crystalline material of claim 9, where the at least one catalytically active metal comprises copper or iron.

11. The microporous crystalline material of claim 10, wherein the catalytically active metal comprises copper Cu, which is present in a CuO of 1-10 wt %.

12. The microporous crystalline material of claim 10, wherein the catalytically active metal comprises iron Fe, which is present in a Fe₂O₃ of 0.2-10 wt %.

13. The microporous crystalline material of claim 8, where said material comprises a mean crystal size ranging from 0.3 to 5 microns.

14. A method of selective catalytic reduction of nitrogen oxides in exhaust gas, said method comprising at least partially contacting said exhaust gas with an article comprising a microporous crystalline material of claim 10.

15. The method of claim 14, where the at least partially contacting step is performed in the presence of ammonia, urea, an ammonia generating compound, or a hydrocarbon compound.

16. A method of synthesizing a microporous crystalline material having a CHA structure and comprising:
a first OSDA that has a general structure of the quaternary ammonium cation as follows: 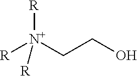
where R is a methyl or ethyl; and
at least one second OSDA.

17. The method of claim 16, wherein the microporous crystalline material has a molar silica to alumina ratio (SAR) of about 8 or higher.

18. The method of claim 16, wherein the SAR ranges from 8 to 50.

19. The method of claim 16, comprising:
mixing sources of alumina, silica, one or more OSDAs, optionally alkali containing additive, water and optionally a seed material to form a gel; and
heating the gel in an autoclave to form a crystalline CHA product.

20. The method of claim 16, wherein the first OSDA and the second OSDA are a hydroxide or a salt chosen from fluoride, chloride, bromide, iodide, or a mixture of thereof.

21. The method of claim 16, wherein the second OSDA comprises a compound chosen from as an amine, monoquaternary ammonium compound, or diquaternary ammonium compound, capable of forming a zeolite with chabazite (CHA) structure.

22. The method of claim 21, wherein the second OSDA is chosen from N,N,N-trimethyl-1-adamantylammonium, N,N-dimethyl-N-ethylcyclohexylammonium, N,N-dimethylpyrrolidinium, N,N-dimethylpiperidinium, N,N-dimethylhexahydroazepinium, benzyltrimethylammonium, and mixtures thereof.

23. The method of claim 16, wherein the first OSDA comprises choline cation.

24. The method of claim 20, further comprising calcining the CH A product, and optionally ammonium-exchanging said CHA product.

25. The method of claim 24, further comprising introducing at least one catalytically active metal into the microporous crystalline material by liquid-phase or solid-phase ion exchange, impregnation, direct synthesis or combinations thereof.

26. The method of claim 25, where the at least one catalytically active metal comprises copper or iron.

27. The method of claim 26, wherein the catalytically active metal comprises copper Cu as CuO of 1-10 wt %.

28. The method of claim 27, wherein the catalytically active metal comprises iron Fe as Fe₂O₃ of 0.2-10 wt %.

29. The method of claim 19, where the alkali containing additive comprises a source of potassium or sodium, or a mixture of thereof.
